(19) United States
(12) Patent Application Publication
(10) Pub. No.: US 2004/0041912 A1
(43) Pub. Date: Mar. 4, 2004

(54) Method and apparatus for video metrology

(76) Inventor: Jiabin Zeng, Huntington Beach, CA (US)

Correspondence Address: CHARLES C.H. WU, 7700 IRVINE CENTER DRIVE, SUITE 710, IRVINE, CA, 92618-3043, US

(21) Appl. No.: 10/233,841

(22) Filed: Sep. 3, 2002

(51) Int. Cl. H04N 5/225

(52) U.S. Cl. 348/207.1

(57) ABSTRACT

The present invention provides a method and apparatus for video metrology by using a digital camera. A digital camera supporting a megapixel resolution is mounted on a stage controlled by a motion controller via the computer. The digital camera is directly coupled to the computer for image data processing through a hardware interface such as IEEE 1394a. The digital camera achieves quick and accurate auto-focusing by dynamic resizing of the resolution of the digital camera. A live capture from the digital camera is sent to the computer by digital signals. A software program processes the digital signal to generate a live image by using DirectDraw. Graphical tools for performing dimensional measurements are also generated using DirectDraw and the background of the graphical tools are painted to a chosen color key.

### BACKGROUND OF THE INVENTION

1. Field of the Invention

The present invention provides a method and apparatus for dimensional measurement, and particularly to a method and apparatus for video based metrology.

2. Description of Related Art

The use of coordinate measuring machines (CMM) for quality control and inspection on manufactured parts and products are very common in different industries. These CMM were considered expensive machinery and were usually only used in precision manufacturing due to the justification of cost. Recently, the advancement in the technology of CMM has produced more affordable and portable CMM. CMM are categorized into contact and contactless, contact meaning that a touch probe such as the Renishaw© Probe makes contact with the work piece and non-contact meaning that an optical probe using laser or photographic technique to make a measurement. The contact-type CMM has been the dominating choice because of its high accuracy, reliability, and unaffectedness by operating environment. However part reduction and product integration and miniaturization have driven parts and products to be more complicated in shape and profile and therefore making them difficult to use contact-type CMM to make measurements. In some industries such as semiconductor and electronics, contactless-type CMM is used extensively for quality control and inspection because of its speed, convenience, and accuracy over contact-type CMM.

FIG. 1 shows a conventional video CMM. Conventional video CMM of various constructions usually contains an optical reader located on a motorized arm which moves along the Z axis and a motorized bed which moves along the X or Y axis for locating the to-be-scanned workpiece. These machines are usually very slow in terms of their movement and speed of translation. Therefore large workpiece usually takes a long time to capture because it has to be divided into individual grids for measurement. The long duration required for inspection and measurement of a single unit causes decrease in production efficiency or quality. The captured image of the workpiece from the optical reader is transferred to a frame grabber in a PC for displaying and performing dimensional measurements. A frame grabber is hardware used to transform the analog video signal from the optical reader into a digital signal for processing in the computer. The captured image is analyzed and displayed on the monitor by special software.

FIG. 2 is a schematic diagram of a video CMM. A video CMM 200 comprises a camera 202, optical elements 204, lighting elements 206, a motorized Z stage 208, a motorized XY stage 210 that is coupled to a computer 220, and a motion controller 240 which is coupled between the motorized XY stage 210 and the computer 220. Some system design may use manual XY and Z stage without using motion controller. The lighting elements 206 are located at the tip of the camera for providing a light source on the workpiece for capture. The optical elements 204 are coupled to the camera 202 for providing focusing and zooming so the workpiece fits into the field of view to the CCD of the camera. The camera 200 captures a real-time online image by the built-in analog CCD and converts the image data into an analog video signal of either NTSC or PAL format. NTSC format supports 640×480 pixels at 29.97 frame/sec and PAL format supports 764×576 pixels at 25 frame/sec.

The focusing of the camera 202 on the Z axis is done by the optical elements 204 in cooperation with the software. Focusing is crucial to the measurements because of the required sharp contrast of the lines and shadows, which cannot be achieved when the image is blurry. A start point for focusing is located on the Z stage 208 where from it moves the camera 202 and the optical elements 20 together to achieve focusing. The movement of the Z-axis is controlled by the motion controller 240 at a calculated linear speed. While the camera 202 and optical elements 204 are moving along the Z axis for obtaining focus, the software captures and calculates the change in contrast of the image. The software controls the movement of the Z stage 208 via the motion controller 240 while determining the Z position with the highest image contrast of a selected area. The Z stage 208 will first move along the scan path from the start point to the end point once and then revert to the previously recorded Z position with the highest image contrast. The speed of focusing in dependent on the continuous capture rate of the camera according to the video signal format. Some system design may use manual Z stage without using motion controller.

The analog video signal is transmitted to the frame grabber in the computer for freezing a frame of the captured image to perform dimensional measurements. The frame grabber is required to provide real-time video capture and onboard non-destructive display because of the strict requirement of the video data. The screen displayed on the monitor is generated by non-destructive overlay to draw graphics on the live display images producing the least amount of distortion. The captured frames are transmitted and stored in the memory of the frame grabber or the computer. Furthermore, the board can stream digitized images to the onboard memory for onboard display without requiring constant processing from the host CPU.

FIG. 4 shows the circuit design of a conventional frame grabber found in an analog CMM system. The main components are NTSC/PAL video encoder 400, TTL drivers and receivers 402, a plurality of multiplexors 404, a plurality of A/C converters 406, a video interface bridge 408, a graphics controller 410, a PLL 414, a sync separator 416, a LUT 418, and a pair of outputs 412. Analog video signals enter the frame grabber via the multiplexors 404 and then are converted into digital signals by the onboard A/D converters 406. The converted digital signals are sent to the configurable LTUs and the video encoder 400 for analog TV output and/or the graphics controller 410 for VGA or digital VGA output depending on the configuration of the board. The graphics controller 410 support non-destructive overlay of video on the captured image from video interface bridge 408. The video interface bridge 408 and graphics controller 410 are further connected host 32-bit/33 Mhz PCI bus (not shown) for receiving control signals from the CPU (not shown) through the bus (not shown).

The design of conventional video CMM is limited to use frame grabber with non-destructive overlay to perform display and measurements, which is low at flexibility. The signal from CCD camera to frame grabber and computer goes through analog to digital conversation will degrade the image quality. The pixel jitter that occurs at digitizing the image by frame grabber affects the measure of accuracy. The conventional video CMM requires dedicated hardware for performing measurements which is high in cost and low in flexibility. Furthermore the captured image size is limited to the number of pixels of the video signal format. A large to-be-scanned workpiece might require multiple individual captures of the workpiece to complete the measurement. Refocusing and movement of the stages will significantly increase the time for measurement leading to higher production cost.

### SUMMARY OF THE INVENTION

The present invention provides a method of and apparatus for video metrology using a digital camera which avoids the above-mentioned disadvantages by the use of a digital signal. The video metrology apparatus comprises a CMM machine mounted with a digital camera, a computer for performing dimensional measurements, and a motion controller for translating the stage and camera focus. A high resolution digital camera nowadays can support image size up to 2048×2048 pixels and the resolution is breaking new grounds at very rapid speed. The resolution of a high quality digital camera is a few times higher than that of a conventional video camera of either NTSC or PAL format. The digital camera streams uncompressed digital image of megapixel color video and acquires digital still-image frames. The captured image data is in digital format which can be directly transmitted to the computer without the need of a frame grabber for data conversion. The digital camera can be directly coupled to the computer via an interface such as IEEEI394a (FireWire), USB 1.0 or 2.0, or Camera Link, and other similar digital camera image capture board. The present invention is not limited to the choice of interface and any high-speed computer interface can be used.

A software program for performing dimensional measurements is provided to process the digital signal captured from the digital camera. The software performs the certain functionalities of the frame grabber, such as continuous live image display, text and graphics non-destructive display. The software program is designed for image documentation, production inspection, and quality control. Live images captured from the digital camera is processed and displayed by DirectDraw which takes raw image data and converts into an internal image. The software program allows user-flexible and programmable parameters such as zoom, lightening, stage mapping, coordinates, and units. The software requires little processing of the host CPU for dimensional measurements after the image data is transmitted to the memory of the computer. Furthermore, a motion controller controlled by the software is coupled to the computer and the CMM machine for providing focus and stage setting of the workpiece.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a picture of a conventional CMM.

FIG. 2 is a schematic diagram of a conventional CMM.

FIG. 3 is a screenshot of a conventional CMM.

FIG. 4 is a circuit layout of a conventional frame grabber with onboard display.

FIG. 5 is a picture of the apparatus for video metrology of the present invention.

FIG. 6 is a schematic diagram of the apparatus for video metrology of the present invention.

FIG. 7 is a flow chart of the image capture operation according to a preferred embodiment of the present invention.

FIG. 8 is a flow chart of the image averaging operation according to a preferred embodiment of the present invention.

FIG. 9 is a flow chart of the auto-focusing operation according to a preferred embodiment of the present invention.

FIG. 10 is a screenshot of an experimental result of a conventional CMM.

FIG. 11 is a screen shot of an experimental result of the apparatus for video metrology of the present invention.

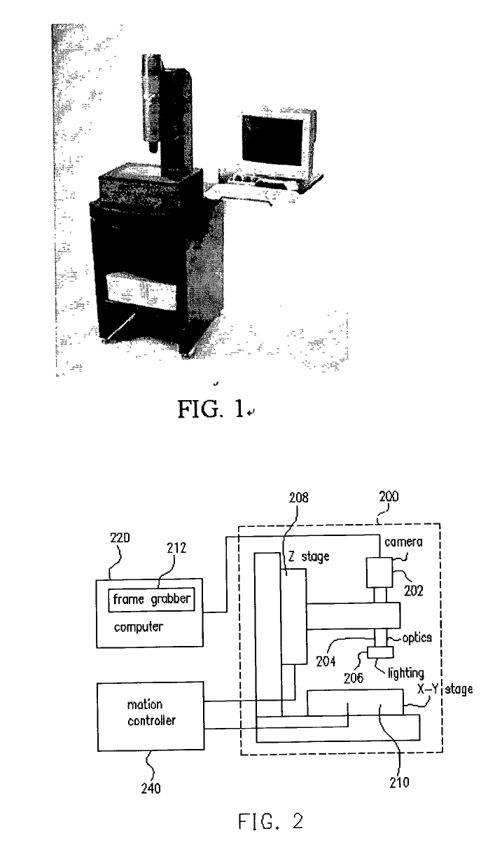

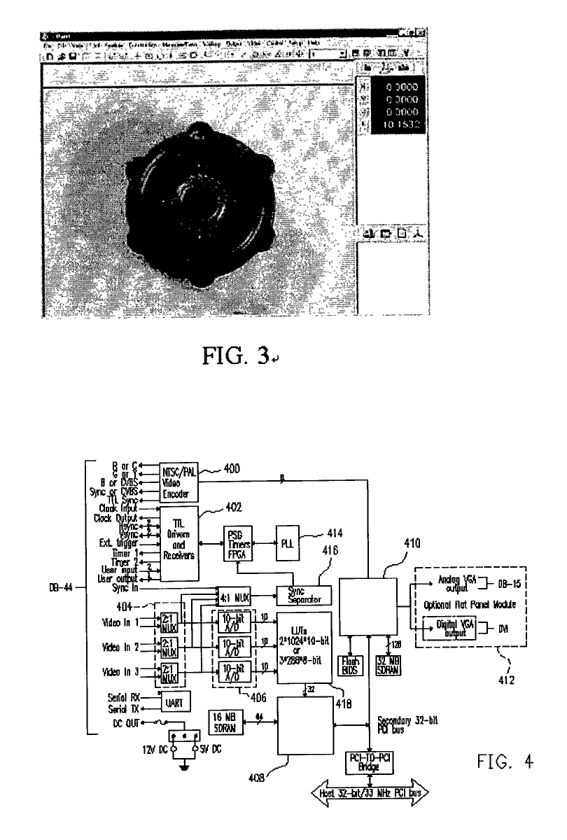

### DETAILED DESCRIPTION OF THE PREFERRED EMBODIEMENTS

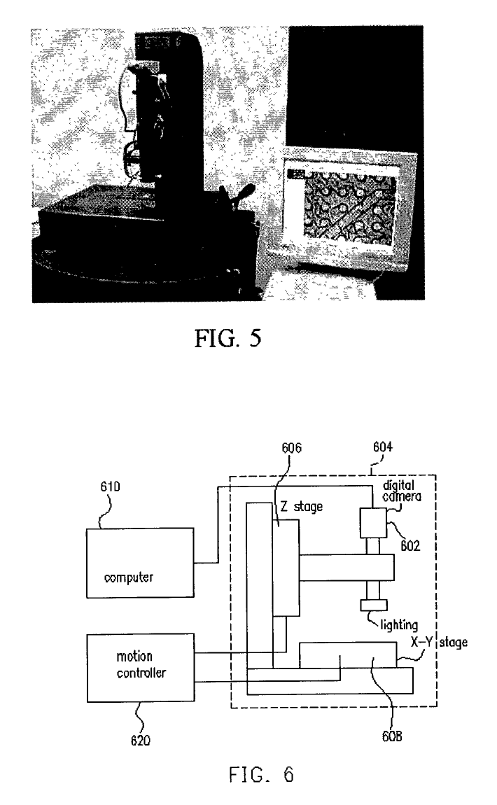

FIG. 5 shows a picture of the video metrology system and FIG. 6 illustrates a schematic diagram of the video metrology system. Please refer to FIG. 6, a video CMM 200 comprising a digital camera 602, lighting elements 604, a Z stage 606, and a XY stage 608 is coupled to a computer 610 and a motion controller 620 which is also coupled to the computer 610. A digital camera 602 supporting megapixels of color image is a CMOS digital camera. The physical interface of the digital camera 202 is IEEE 1394a, 6-pin ports which has a maximum transfer rate of 400 MB/sec transferring through a TWAIN interface on a computer running Windows© operating system. The present invention is not limited to the resolution and the interface of the digital camera and the operating system of the computer. The digital camera 602 transfers uncompressed 8 bit digital raw data directly to the computer for the software to perform dimensional measurements.

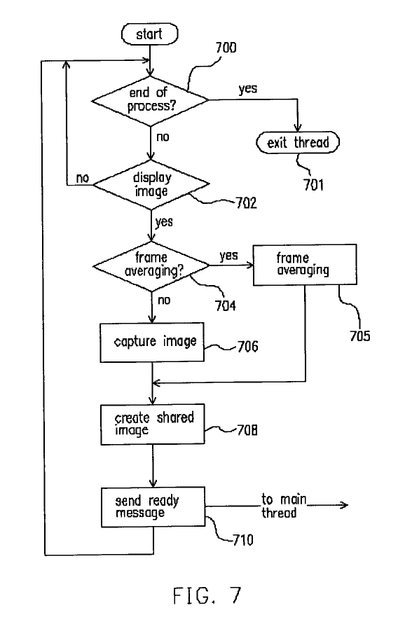

FIG. 7 shows the flow chart of the capturing operation of the method of video metrology of the present invention. The software program controls the CMM machine 200, digital camera 202, motion controller 240, and data transfer and processing. The software program supports simultaneous transfer of data in and out of the computer. The software program is applicable to any digital cameras using any high-speed interface and does not require any additional hardware. Moreover the software is backwards compatible with conventional video image reader with a frame grabber running analog signals without the need of onboard display and non-destructive overlay.

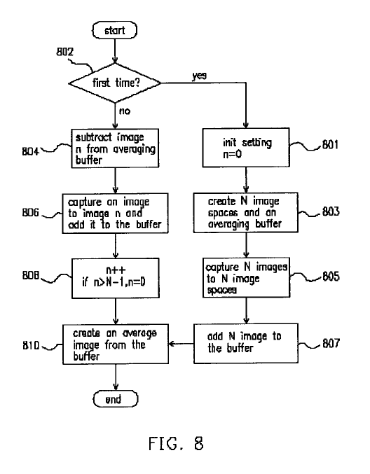

The software program captures continuous raw image data from the digital camera 602 in capture mode. Once a desired frame is captured in the capture mode, the software program switches to the program mode where different actions for performing dimensional measurements can be carried out. In the capture mode, step 700 checks for end of process because of the continuous loop set in the capture mode. If it is the end of process, the operation terminates and the software program exits the capture mode. If end of process is not detected, the operation continues and proceeds to step 702. Step 702 controls the display of image. If there is no image to be displayed, the operation reverts back to step 700. The operation moves to step 704 where a frame averaging option can be selected to remove random noise from the captured image based on some mathematical equations. This feature is useful for X-ray applications because noise can greatly affect the reflection of the light waves causing unacceptable results. The image quality using image averaging is greatly enhanced for better measurement accuracy. If frame averaging is required, a frame of image will be captured according to the frame averaging method which is furthered discussed in FIG. 8. If the quality of the raw image capture is adequate, the operation proceeds to step 706 where an image frame is captured directly from the digital camera 602. The resulting digital signal will be directly sent to the computer without any further any A/D conversion. Moving on to step 708, after an image frame is captured, a share image is created for the program mode to perform different actions on the captured image frame. After completion in generating the share image, a ready message is sent to display indicating that the capture mode is ready again for capturing the next image. The capture mode runs simultaneously with the program mode by using a shared image. The software can easily switch to either mode for performing the required tasks from the user. The capture process continues even after a shared image is generated and runs in the background when the software program is in the program mode.

FIG. 8 shows the flow chart of the image averaging operation. In step 800, it is determined whether the captured image is a new image or an in-process image. There are two different tracks for creating an average image. If the input image is new image, in step 801, the initial value of image counter n is set to zero. A buffer for N number of images is created in step 803. In step 805, the digital camera captures a sequence of N number of image frames. The images are then stored in the buffer in step 805. In step 808, an average image is generated from the sequence of images stored in the buffer. If the input image is an in-process image, in step 802, the n^{th} image is subtracted from the buffer. In step 804, a new image is captured and stored in the buffer. A logic relationship is applied to the buffer counter where n++, if n>N−1 n=0 in step 806. In step 808, an average image is generated from the buffer.

The program mode offers the full capability of the software by providing a wide variety of tools for the user to analyze, compare, and manipulate the captured image data. The program mode generates several DirectDraw surfaces by using DirectDraw. One surface is set for display and is called an image surface. This image is what the user sees on the display and perform different actions. Other surfaces are set as overlay surfaces to overlay graphics and images over the image surface, wherein a key color is set to all overlay surfaces. One of the overlay surfaces is a tool surface that is used to display the graphics of the edge detection tool. The software paints the background of the tool surface the key color and draw the active tools on top. However the tool surface needs to be redrawn when tools such as sizing, moving, or rotating are used. The present invention takes advantage of DirectDraw which allows direct processing of the digital signal from the digital camera without the need of any frame grabbers requiring onboard graphics engine and non-destructive overlay. The program mode receives the message from the capture process indicating that a shared image is readily stored in memory and draws an image surface. The software generates two surfaces by using DirectDraw, one is an image surface and the other is a tool surface. The user can see live image display and stable graphics because of the high-speed drawing provided by the method of the present invention. Most of the host CPU time is used for image capture and display.

In the program mode, the software optimizes the CPU processing power and time for stage movement via motion controller 620, and image processing. Therefore the software only allocates resources when capturing images with the above mentioned methods when it is required. Instead of using live capture from the capture, the software can take a snapshot of the workpiece and perform actions afterwards. This mode will allow the computer to have more resources to perform heavy operations.

The image capture rate of the digital camera varies and depends on the hardware interface and the size of the images. Digital camera can support different resolutions at different frame rate which allows high flexibility. For a selected image size, the capture rate is limited to a corresponding maximum. A smaller image can achieve a higher capture rate because of the linear anti-proportional relationship between resolution and capture rate. Auto focusing of the camera is dependent on the capture rate and therefore better accuracy in auto focus is achieved with a faster capture rate. The software takes advantage of the scalable resolution of a digital camera and uses dynamic image sizing during auto focusing. This ensures that the operation of auto focus to be done precisely in the least amount of time. Larger image size will be used when contrast difference is high and smaller image size will be used when contrast difference is low. User can also select a focus area for the digital camera 602 to perform auto focus. For example, for a digital camera supporting a maximum resolution of 1280×1024, the software will select a resolution as small as 80×60 when doing auto-focusing.

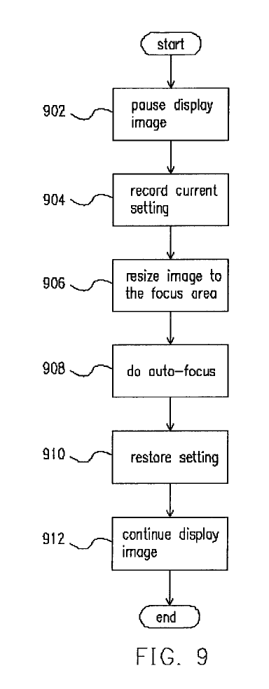

Please refer to FIG. 9, the operation of auto focusing is illustrated. In step 900, a desired display image being displayed on the monitor is paused during the live capture of the digital camera for performing auto-focusing. The current settings of the stages and the camera are recorded for referencing in step 902. Proceeding to step 904, the size of the image will be dynamically resized according to the focus area. In step 906, auto-focusing then starts after the initial image size is dynamically resized. During auto-focusing, the contrast level and Z position of the camera is being recorded as a continuation from step 902 for locating the correct focal point. After the camera has done a pass on the Z stage, the recorded data is compared to find the focal point with the highest contrast. The camera then automatically moves to the focal point and the auto-focus operation completes. In step 908, the digital camera restores the original setting of the digital camera because the auto-focus operation requires changes to the settings of the digital camera. Finally in step 908, the digital camera 602 restarts the capture operation and continues to display image. Comparing to the NTSC 29.97 frames/sec and PAL 25 frames/sec capture rate, the software can achieve a higher capture rate up to 140 frames/sec while getting better auto-focus accuracy.

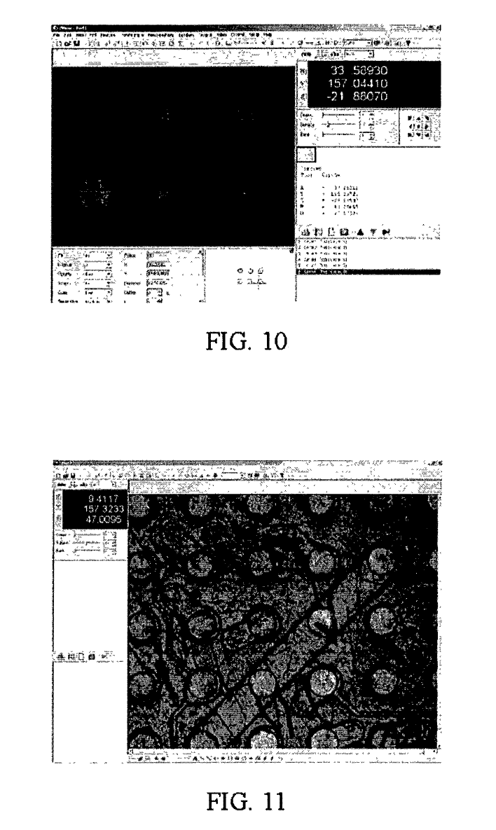

FIG. 10 is a screenshot of a conventional metrology system using a NTSC video camera with a frame grabber with onboard camera and non-destructive graphics overlay. The video camera has a ⅓″ CCD combined with a frame grabber that captures the NTSC video signal in 640×480 pixels. The frame grabber and NTSC video camera supports up to a 29.97 frame/sec capture rate. The computer monitor screen resolution is set to 1024×768 pixels. It can be seen from the screenshot that the NTSC camera can only capture 6 circle of a sample at its pixel limitation.

FIG. 11 is a screenshot of the method and apparatus for video metrology using an IEEE 1394 digital camera. The digital camera with a ½″ CCD is connected to the computer via a IEEE 1394 FireWire port and supports a maximum image size of 1280×1024 pixels. The capture rate of the digital camera is 12 frame/sec at this resolution. It can been seen from the screenshot that the digital camera can capture about 25 circles of the same sample at its resolution.

Comparisons on different aspects of the performance are conducted based on the real experiments conducted by the inventors as shown in FIG. 10 and FIG. 11. A to-be-tested sample contains a plurality of equally spaced circles in both the X and Y direction. If the two systems have the same pixel size, the digital camera supporting 1280×1024 pixels has four times the display area as the analog NTSC camera supporting 640×480 pixels. Based on this relationship, if the NTSC video camera captures 6 circles the digital camera should theoretically capture 6×4 circles which is 24 circles. FIG. 10 proves that the method and apparatus for video metrology of the present invention conforms to the theory. The total capture time of the entire workpiece is greatly reduced due to the larger capture size supported by the digital camera. The following table shows the required time for each operation of both systems.

TABLE 1

| | Prior Art | Present Invention |
|---|---|---|
| One Stage Movement | 2 s | 2 s |
| One Image Capture | 0.1 s | 0.2 s |
| One Measurement | 0.05 s | 0.05 s |
| Total Measuring Time for | 9.6 s | 3.4 s |
| 24 circles | | |

Table 1 shows that time for stage movement and measurement is identical but the present invention requires a longer time for image capture. However this longer capture time is justified because the method and apparatus for video metrology of the present invention can finish the entire capture of 24 circles is approximately ⅓ the time of the prior art. The total time for performing dimensional measurements on 24 circles is calculated by adding the time for number of stage movements, image capture, and measurements together. Prior art requires 4 * (2s+0.1s+6*0.05s)=9.6s. Each image frame capture of the prior art requires a stage movement of 2s, an image capture of 0.1s, and six measurements of 0.05s for the six circles. The prior art requires 4 individual captures to complete the scanning of the workpiece, therefore the total time required is four times the time required for one image frame capture. The present invention only requires one image frame capture for the entire product for performing dimensional measurements. Therefore the total time required is 2s+0.2s+24*0.05s for only one stage movement, one image, and 24 measurements for the 24 circles. The reduction in time benefits from eliminating unnecessary translation of the stage movement since the speed of the stages are slow and steady.

On top of improvement in measuring time, the measuring accuracy is also greatly improved. The method and apparatus for video metrology of the present invention eliminates the use of a frame grabber which greatly improves picture quality. A frame grabber can only receives an analog video signal so no matter if the camera itself is analog or digital, the output of the camera is converted into an analog video signal. A frame grabber needs to re-digitize the image based on the analog input for data manipulation and therefore lower the resolution. Pixel jitter of the frame grabber will affect measurement results and expensive circuitry needs to be implemented to prevent pixel jitter. Frame grabbers also require PLL circuitry, programmable look-up tables, and video amplifiers to coup with the shortcomings of an analog video signal. The overall measurement accuracy of the entire workpiece is more precise because stage movement is eliminated. There has to be dimensional and movement tolerance error during the stage movement which affects the coherence of the measurement results.

The present invention realizes the following advantages. The method and apparatus for video metrology of the present invention allows great flexibility because it supports all kinds of camera and especially digital camera. The apparatus does not require a frame grabber with complicated onboard display and non-destructive overlay. The Measurement time is greatly reduced due to the elimination of unnecessary stage movements. Furthermore, the measurement time is further reduced because auto-focusing is also faster. The software program uses dynamic resizing of image size to fit the focus area for performing auto-focusing. Capture rate can be boosted to 140 frames/sec when using a image size of 80×60 pixels. The is approximately four times faster than the 29.97 frames/sec of the NTSC video signal.

It will be apparent to those skilled in the art that various modifications and variations can be made to the structure and method of the present invention without departing from the scope or spirit of the present invention. In view of the foregoing description, it is intended that the present invention covers modifications and variations of this invention provided they fall within the scope of the following claims and their equivalents.

What is claimed is:

1. An apparatus for video metrology comprising:
a digital camera with an industry-standard hardware interface for transmitting a digital signal of a captured image; and
a computer coupled to the digital camera via the industry-standard hardware interface for receiving the digital signal and overlaying graphical tools on the captured image by DirectDraw for performing dimensional measurements.

2. The apparatus in claim 1, wherein the digital camera supporting megapixels of color image is selected from a group consisting of CMOS, CCD, and CID.

3. The apparatus in claim 1, wherein the industry-standard hardware interface is a high-speed computer hardware interface selected from a group consisting of IEEE 1394a, USB 1.0, USB 2.0, Camera Link, and other similar image capture boards.

4. The apparatus in claim 1 further comprising a stage for providing X, Y, and Z axis movement of the digital camera.

5. The apparatus in claim 4 further comprising a motion controller that is coupled to the stage and the computer for controlling movements of the digital camera.

6. An apparatus for video metrology for making contactless measurements of objects comprising:
a digital camera with an industry-standard hardware interface for transmitting a digital signal of a captured image;
a computer coupled to the digital camera via the industry-standard hardware interface for receiving the digital signal and overlaying graphical tools on the captured image by DirectDraw for performing dimensional measurements;
a stage for providing X, Y, and Z axis movement for the digital camera, wherein the Z axis movement allows auto-focusing of the digital camera; and
a motion controller coupled to the stage and the computer for controlling movements of the digital camera.

7. The apparatus in claim 6, wherein the digital camera supporting megapixels of color image is selected from a group consisting of CMOS, CCD, and CID.

8. The apparatus in claim 6, wherein the industry-standard hardware interface is a high-speed computer hardware interface selected from a group consisting of IEEE 1394a, USB 1.0, USB 2.0, and Camera Link.

9. A method for video metrology for making contactless measurements of objects, wherein a digital camera mounted on a stage controlled by a motion controller transmits a digital signal to a computer and a monitor for displaying an image, the method comprising:
capturing a live image with a digital camera;
sending a digital signal of the captured live image from the digital camera to the computer,
generating a live image on the monitor from the captured live image using DirectDraw;
overlaying graphical tools on the live image using DirectDraw; and
performing dimensional measurements on the shared image.

10. The method of claim 9, wherein a resolution of the digital camera for capturing is adjustable.

11. The method of claim 9, wherein generating a live image further comprising averaging a sequence of captured images for removing noise from the image.

12. The method of claim 9, wherein overlaying graphical tools on the live image further comprising setting a background of the graphical tools is painted to a chosen key color.

13. The method of claim 9 further comprising auto-focusing for moving the digital camera to a correct focal point.

14. The method of claim 13, wherein auto-focusing further comprising dynamic resizing of an image size of the captured live image.

15. A method for video metrology for making contactless measurements of objects, wherein a digital camera mounted on a stage controlled by a motion controller transmits a digital signal to a computer and a monitor for displaying an image, the method comprising:
auto-focusing of digital camera;
capturing a live image with a digital camera;
sending a digital signal of the captured live image from the digital camera to the computer,
averaging a sequence of captured images to remove noise from the live image;
generating a live image on the monitor from the captured live image using DirectDraw;
overlaying graphical tools on the live image using DirectDraw;
painting a background of the graphical tools to a chosen key color; and
performing dimensional measurements on the shared image.
